(19) United States
(12) Patent Application Publication
(10) Pub. No.: US 2006/0141392 A1
(43) Pub. Date: Jun. 29, 2006

(54) Photosensitive resin composition, method for preparing the same, and dry film resist comprising the same

(76) Inventors: In-Ho Yoon, Suwon-city (KR); Bong-Gi Kim, Hwaseong-city (KR); Chang-Seok Rho, Busan-city (KR); Sang-Ki Kang, Jeonju-city (KR); Kyung-Rock Byun, Hwaseong-city (KR); Chan-Seok Park, Hwaseong-city (KR)

Correspondence Address: FISH & RICHARDSON PC, P.O. BOX 1022, MINNEAPOLIS, MN, 55440-1022, US

(21) Appl. No.: 11/292,411

(22) Filed: Nov. 30, 2005

(30) Foreign Application Priority Data
Nov. 30, 2004 (KR) 10-2004-0099483

(51) Int. Cl. G03C 1/76

(52) U.S. Cl. 430/270.1

(57) ABSTRACT

The present invention relates to a photosensitive resin composition, a preparation method thereof, and a dry film resist comprising the same. More particularly, the photosensitive resin composition of the present invention is directed to a photosensitive resin composition including a) an alkali-soluble acrylate resin, b) a cross-linking monomer having at least two ethylenic double bonds, and c) a phosphine oxide based photopolymerization initiator and an acridon based photopolymerization initiator. According to the photosensitive resin composition and the dry film resist, it is easy to finely pattern using a laser direct image with high density and the dry film has excellent sensitivity, resolution, and adhesiveness to the substrate.

### CROSS REFERENCE TO RELATED APPLICATION

This application claims priority to and the benefit of Korean Application No. 10-2004-0099483 filed in the Korean Patent Office on Nov. 30, 2004, the entire content of which is incorporated hereinto by reference.

### BACKGROUND OF THE INVENTION

1. Field of the Invention

The present invention relates to a photosensitive resin composition, a preparing method, and a dry film resist comprising the same, more specifically for pattering the barrier ribs of Plasma display panel (PDP).

2. Description of the Related Art

A plasma display panel (PDP) is a flat display device using a plasma phenomenon, which is also called a gas-discharge phenomenon since a discharge is generated in the panel when a potential greater than a certain level is applied to two electrodes separated from each other under a gas atmosphere in a non-vacuum state. Such a gas-discharge phenomenon is applied to display an image in the plasma display panel. At present, a generally used plasma display panel is a reflective alternating current driven plasma display panel. On a rear substrate, phosphor layers are formed in discharge cells compartmentalized by a barrier rib. The above plasma display panel forms its outer shape by positioning a rear substrate and a front substrate (for convenience, referred to as a first substrate and a second substrate, respectively) spaced with a predetermined distance therebetween and substantially parallel with each other like other flat panel display devices such as vacuum fluorescence display (VFD) or a field emission display (FED). The substrates are joined using a binder along their circumferences to form a discharge cell in a vacuum state.

Recent developments in the display industry are spurring work for manufacture of display panels with high resolution. One of the works is to form finely-patterned barrier rib in a short time.

In the prior art, a pattern of barrier rib for a plasma display panel is generally formed by coating and drying a paste composition for preparing barrier rib, forming a dry film the dried composition, covering a mask with a predetermined pattern, and exposing with Ultraviolet light. However, the conventional pattering method cannot be applied for large-sized panel, and requires a special mask adapted for newly-changed pattern. If the mask has defects, all panel prepared by using the mask have defects.

To resolve the problems in the prior art, the patterning method using a laser direct image develops to finely-pattering the large-sized panel by removing a photomask and achieving resolution of wavelength of light source. However, the direct image pattering method requires a long exposure time and work time to lower the productivity compared to the patterning method using the photomask.

### SUMMARY OF THE INVENTION

To resolve the problems in the prior art, an object of the present invention is to provide a photosensitive resin composition with an excellent sensitivity compared to the conventional photosensitive resin composition, to finely-pattern using a direct image with laser even though the photomask is not used. In addition, another object of the present invention is to provide a preparing method of the photosensitive resin composition, and the dry film resist comprising the photosensitive resin composition.

An embodiment of the present invention provides a photosensitive resin composition comprising a) the alkali-soluble acrylate resin, b) the cross-linking monomer having at least two ethylenic double bonds, and c) the phosphine oxide based photopolymerization initiator and the acridon based photopolymerization initiator.

Another embodiment of the present invention provides a method of preparing a photosensitive resin composition comprising the steps of:

polymerizing alkali-soluble acrylate resin from at least a monomer selected from the group consisting of unsaturated carboxylic acid monomer, aromatic monomer, phosphate ester-containing monomer, and aliphatic acrylic monomer; and

mixing the alkali-soluble acrylate resin, cross-linking monomer having at least two ethylenic double bonds, a phosphine oxide based photopolymerization initiator, and an acridon based photopolymerization initiator.

Yet another embodiment of the present invention provides a dry film resist including the photosensitive resin composition.

### DETAILED DESCRIPTION OF THE PREFERRED EMBODIMENTS

A more complete appreciation of the present invention, and many of the above and other features and advantages of the present invention, will be readily apparent as the same becomes better understood by reference to the following detailed description.

The photosensitive resin composition can form a predetermined pattern by sensitively reacting to the light, which includes a) alkali-soluble acrylate resin, b) cross-linking monomer having at least two ethylenic double bonds, and c) a phosphine oxide based photopolymerization initiator and an acridon based photopolymerization initiator.

Preferably, the photosensitive resin composition includes 40 to 100 parts, or more preferably 60 to 80 parts by weigh of the cross-linking monomer having at least two ethylenic double bonds based on 100 parts by weight of the alkali-soluble acrylate resin. In addition, the phosphine oxide based photopolymerization initiator is contained in an amount of 1 to 5 parts by weight, and the acridon based photopolymerization initiator is contained in an amount of 0.5 to 2 parts by weight based on 100 parts by weight of the alkali-soluble acrylate resin. The amount in total of the phosphine oxide based photopolymerization initiator and the acridon based photopolymerization initiator is 1.5 to 7 parts by weight.

If the amount of cross-linking monomer is less than 40 parts by weight based on 100 parts by weight of the alkali-soluble acrylate resin, the insufficient curing makes it difficult to pattern. If the amount of cross-linking monomer exceeds 100 parts by weight, the pattern is torn away in developing process, and has lower directionality.

In addition, if the amount of phosphine oxide based photopolymerization initiator is less than 1 parts by weight, the curing degree in lower part of the pattern decreases. If the amount exceeds 5 parts by weight, remaining layer in the upper part of pattern decreases after developing. If the acridon based photopolymerization initiator is contained less than 0.5 parts by weight based on 100 parts by weight of alkali-soluble acrylate resin, remaining layer in the upper part of pattern decreases after develping. If the amount is more than 2 parts by weight, the curing degree of the lower part of pattern deceases.

If the amount in total of the phosphine oxide based photopolymerization initiator and acridon based photopolymerization initiator is less than 1.5 parts by weight based on alkali-soluble acrylate resin 100 parts by weight, the low sensitivity to light makes it difficult to pattern normally and lowers the directionality of pattern. The amount in total exceeds 7 parts by weight causes a problem in the storage stability.

The alkali-soluble acrylate resin has weight-average molecular weight of 20,000 to 100,000, or more preferably 30,000 to 70,000. If the weight average molecular weight is less than 20,000, the sensitivity of the photosensitive composition and an etching resistance decease. If the weight average molecular weight is more than 100,000, the length of lower part of pattern increases.

In addition, a glass transition temperature of the alkali-soluble acrylate resin is 100° C. or higher preferably, or 150 to 200° C. more preferably. If the glass transition temperature is lower than 100° C., the composition leaks out in a dry film state.

Preferably, the alkali-soluble acrylate resin is prepared by polymerizing at least one selected from the group consisting of i) unsaturated carboxylic acid monomer, ii) aromatic monomer, iii) phosphate ester-containing monomer, and iv) aliphatic acrylic monomer. The monomer for preparing the alkali-soluble acrylate resin includes the unsaturated carboxylic acid monomer as essential component more preferably.

The unsaturated carboxylic acid monomer improves alkali-solubility of acrylate resin. Examples of the unsaturated carboxylic acid monomer includes at least one selected from the group consisting of acrylic acid, methacrylic acid, itaconic acid, maleic acid, furmaric acid, vinyl acetate and acid anhydride thereof.

In polymerizing the alkali-soluble acrylate resin, the amount of unsaturated carboxylic acid monomer is 20 to 50 weight % of an amount in total of monomer(s) preferably. If the amount of unsaturated carboxylic acid monomer is less than 20 weight %, the developing time is long after exposing. If the amount is more than 50 weight %, it has disadvantages in gelling problems of polymerizing process, difficulty in controlling the polymerization degree, and decreased storage stability of photosensitive resin composition.

An preferred examples of the aromatic monomer includes at least one selected from the group consisting of styrene, benzylmethacrylate, benzylacrylate, phenylacrlyate, phenylmethaacrlyate, 2-nitrophenylacrlyate, 4-nitrophenylacrlyate, 2-nitrophenylmethaacrlyate, 4-nitrophenylmethaacrlyate, 2-nitrobenzylmethacrylate, 4-nitrobenzylmethacrylate, 2-chlorophenylacrlyate, 4-chlorophenylacrlyate, 2-chlorophenylmethaacrlyate, and 4-chlorophenylmethaacrlyat.

The aromatic monomer is contained in an amount of 15 to 45 weight % of an amount in total of monomer(s) preferably, or more preferably 20 to 40 weight %. If the amount of aromatic monomer is less than 15 weight %, the pattern can tear away due to decreased adhesiveness to the barrier rib in developing process, and the stable pattern cannot be obtained due to deteriorated directionality of pattern. If the amount exceeds 45 weight %, longer developing time is required, the composition can fall to pieces, and the film resist can not be removed completely due to increased heat resistance.

The phosphate ester-containing monomer improves adhesiveness of polymer and controls the acid value in a small usage amount. The various kinds of phosphate ester-containing monomer are used depending on the terminal double bond group of methacrylate. The preferred example is at least one selected from the group consisting of pentaethyleneglycol phosphate monomethacrylate, pentapropyleneglycol phosphate monomethacrylate, and hexaethyleneglycol phosphate monomethacrylate.

An amount of the phosphate ester-containing monomer is 1 to 15 weight % of an amount in total of monomer(s), or more preferably 5 to 10 weight %. If the amount of the phosphate ester-containing monomer is less than 1 weight %, the sufficient adhesiveness of the film can not be obtained. If the amount exceeds 15 weight %, the gelling occurs in polymerizing process, the film peels out due to decreased resistance to alkali in developing process, and the directionality of formed pattern can be decreased.

The aliphatic acrylic monomer controls the glass transition temperature and the polarity of polymer. The preferred example of aliphatic acrylic monomer is at least one selected from the group consisting of 2-hydroxyethylacrylate, 2-hydroxyoctylacrylate, methylacrylate, ethylacrylate, 2-hydroxyethyl methacrylate, 2-hydroxyoctylmethacrylate, methylmethacrylate, ethyl methacrylate, and n-butylacrylate. The amount of aliphatic acrylic monomer can be selected in considering the glass transition temperature, heat resistance, and hydrophilic property of the acrylate resin. The aliphatic acrylic monomer is contained in 10 to 50 weight % of all monomers preferably.

The alkali-soluble acrylate resin can be prepared by polymerizing the monomer(s) in polar solvent suitable for preventing the gelling of monomer. The preferred example of the solvent is at least one selected from the group consisting of tetrahydropuran, dioxan, dimethylaminoformaldehyde, methylethylketone, carbitol, gamma butyrolactone, and propyleneglycolmonomethylether.

The preferred example of cross-linking monomer having at least two ethylenic double bonds in the photosensitive resin composition is at least one selected from the group consisting of 1,4-butanediacrylate, 1,3-butyleneglycoldiacrylate, ethyl eneglycoldiacrylate, pentaerythritoltetraacrylate, triethyl leneglycoldiacrylate, polyethyleneglycoldiacrylate, dipentaerythritoldi acrylate, solbitoltriacrylate, bisphenol A diacrylate derivative, trimethylpropanetriacrylate, ethyleneoxide added triethylpropanetriacrylate, dipentaerythritolpolyacrylate, 1,4-butanedioldimethacrylate, 1,3-butylleneglycoldimethacrylate, ethyl leneglycoldimethacrylate, pentaerythritoltetramethacrylate, triethyleneglycoldimethacrylate, poly ethyleneglycoldimethacrylate, dipentaerythritoldimethacrylate, solbitoltrimethacrylate, bisphenol A dimethacrylate derivative, trimethylpropanetrimethacrylate, ethyleneoxide added trimethylpropanetrimethacrylate, and dipentaerythritolpolymethacrylate.

The phosphine oxide based photopolymerization initiator is at least one selected from the group consisting of the compounds represented by the following formula 1: 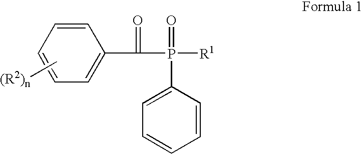
wherein, R¹ is a phenyl, alkyl, or trialkylbenzoly group, R² is independently C1 to C6 alkyl group, and n is an integer of 0 to 3.

The preferred example of the compound represented by formula 1 is at least one selected from the group consisting of (2,4,6-trimethyl benzoyl)-phenylphosphine oxide and bis(2,4,6-trkmethylbenzoly)-phenylphosphine oxide.

The acridon based photopolymerization initiator the acridon based photopolymerization initiator is at least one selected from the group consisting of the compounds represented by the following formula 2: 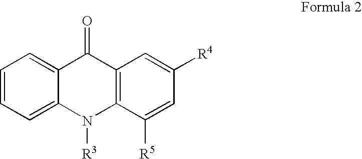
wherein, R³ is a C1 to C6 alkyl, R⁴ is a C1 to C2 alkyl or halogen, and R⁵ is a C1 to C2 alkyl or halogen.

The preferred example of the compound represented by formula 2 is at least one selected from the group consisting of 10-methylacridone, 10-butyl-2-chloroacridone, 10-butyl-2-isopropylacridone, and 10-butyl-2,4-diethylacridone.

In addition to a) alkali-soluble acrylate resin, b) cross-linking monomer having at least two ethylenic double bonds, and c) phosphine oxide based photopolymerization initiator and acridon based photopolymerization initiator, the photosensitive resin composition according to the present invention further includes at least one selected from e) dye, f) solvent, and g) additive for improving coating property.

The preferred example of dye is at least one selected from the group consisting of leuco crystal violet, tribromomethylphenylsulfone, diamond green GH, Rhodamine B, auramine base, paramagenta, methyl orange, methylene blue, crystal violet, ethyl violet, pthalocyanine green, mansic blue 20, and Light green B.

The preferred example of additive for improving coating property is at least one selected from the group consisting of polyester modified dimethylpolysiloxane, polyhydroxycarboxylic acid amide, silicone based polyacrylate copolymer, fluorinated paraffin, etc.

The solvent can be suitably selected in considering the solubility and coating property of photosensitive resin composition. The preferred example of the solvent is at least solvent selected from the group consisting of ethyleneglycolmonomethyletheracetate, propyleneglycolmonomethylether, propyleneglycolmethyletheracetate, propyleneglycolmonoethyl etheracetate, diethyl leneglycoldimethylether, diethyl eneglycolmethylethyl ether, cyclohexanone, 3-methoxypropionic acid ethyl, 3-ethoxypropionic acid methyl, 3-ethoxypropionic acid ethyl, methylethylketone, isopropylalcohol, ethanol, and methanol.

The amounts of e) dye, f) solvent, and g) additive can be suitably selected, but are not limited particularly.

In addition, a photosensitive resin composition is prepared by polymerizing alkali-soluble acrylate resin from at least a monomer selected from the group consisting of unsaturated carboxylic acid monomer, aromatic monomer, phosphate ester-containing monomer, and aliphatic acrylic monomer; and mixing the alkali-soluble acrylate resin, cross-linking monomer having at least two ethylenic double bonds, phosphine oxide based photopolymerization initiator, and acridon based photopolymerization initiator

The amount and kind of the monomer for polymerizing the alkali-soluble acrylate resin the same as those of unsaturated carboxylic acid monomer, aromatic monomer, phosphate ester-containing monomer, and aliphatic acrylic monomer.

The alkali-soluble acrylate resin can be obtained by mixing and polymerizing the four kinds of monomers, suitable polar solvent, and low temperature polymerization initiator. The polymerizing process, the temperature is not limited particularly, but 40 to 80 μl preferably.

The preferred solvent used for polymerizing the alkali-soluble acrylate resin is at least one selected from tetrahydropuran, dioxan, dimethylaminoformaldehyde, methylethylketone, carbitol, gammabutryolactone, and propyleneglycolmonomethylether.

In addition, the preferred example of low temperature polymerization initiator is at least one selected from azoamidine based initiator, azonitrile based initiator, and azoester based initiator.

The acrylate resin is mixed with b) cross-linking monomer having at least two ethylenic double bonds, and c) the phosphine oxide based photopolymerization initiator and the acridon based photopolymerization initiator to prepare the photosensitive resin composition of the present invention. In addition, at least one selected from e) dye, f) solvent, and g) additive for improving coating property can be added in the mixing step as occasion demand.

The preferred example and amount of the cross-linking monomer, the phosphine oxide based photopolymerization initiator, the acridon based photopolymerization initiator, dye, solvent and additive are the same as described above.

The photosensitive resin composition can be used by coating itself as a photosensitive resist for PDP, or can be coated and dried on polymer film to produce dry film resist for PDP.

The polymer film included in dry film resist can be that used for preparing the dry film resist generally, and more preferably polyethyleneterephthalate(PET) film or polyethylene film. The thickness of the film is 15 μm to 30 μm preferably. If the thickness is less than 15 μm, the film is easy to tear due to low tension. If the thickness is more than 30 μm, transmission decreases in exposing process due to low turbidity.

One side of the polymer film is coated by the photosensitive resin composition of the present invention in a certain thickness on, dried, and then is overlaid by the polymer film again to produce the dry film resist.

The following examples illustrate the present invention in further detail. However, it is understood that the present invention is not limited by these examples.

### EXAMPLES 1 AND 2

### Preparation of Alkali-Soluble Acrylate Resin

The alkali-soluble acrylate resins of Examples 1 and 2 were prepared by polymerizing the components and compositions shown in Table 1 at a temperature of 45°. Propyleneglycol monomethyl ether (PGME) as the solvent in the polymerizing was used in an amount of 60 parts by weight to 40 parts by weight of monomers. The low temperature polymerization initiator was an ester based initiator.

TABLE 1
(unit: parts by weight)

| Component | | EXAMPLE 1 | EXAMPLE 2 |
|---|---|---|---|
| Unsaturated carboxylic acid | MA | 25 | 25 |
| monomer | | | |
| Aromatic monomer | BM | 22 | 22 |
| Phosphate ester-containing | PAM-100 | 7 | — |
| methacrylate monomer | | | |
| Phosphate ester-containing | PAM-200 | — | 7 |
| methacrylate monomer | | | |
| Aliphatic acrylic monomer | HEMA | 20 | 20 |
| Aliphatic acrylic monomer | MMA | 26 | 26 |
| Solvent | PGME | 150 | 150 |
| Molecular weight | | 40,000 | 42,000 |

Note:
benzylmethacrylate: BM
methacrylic acid: MA
2-hydroxyethyl methacrylate: HEMA
Phosphate ester-containing methacrylate monomers: RHODIA, PAM-100 and PAM-200:
Methylmethacrylate: MMA

### EXAMPLES 3 TO 7 AND COMPARATIVE EXAMPLES 1 TO 2

### Preparation of Photosensitive Resin Composition

The alkali-soluble acrylate resins of Examples 1 and 2 were dissolved by adding the cross-linking monomer, the photopolymerization initiator, and dye according to the compositions shown in Table 2, agitated for 2 hours at a room temperature of 25° C., and then filtered to remove impurities so as to produce the photosensitive resin compositions of Examples 3 to 7 and Comparative Examples 1 to 2.

TABLE 2
(unit: parts by weight)

| | | | | | | | Comparative | |
|---|---|---|---|---|---|---|---|---|
| | | Example | | | | | Example | |
| Component | | 3 | 4 | 5 | 6 | 7 | 1 | 2 |
| Acrylate resin | Resin 1 | 100 | — | 50 | 100 | 100 | 100 | 100 |
| | Resin 2 | — | 100 | 50 | — | — | — | — |
| Cross-linking monomer | TMP(EO)₃TA | 24 | 24 | 24 | 24 | 24 | 24 | 24 |
| Cross-linking monomer | BPA(EO)₁₀DA | 48 | 48 | 48 | 24 | 48 | 48 | 48 |
| Phosphine oxide based | I-819 | 4 | 4 | 4 | 4 | 2 | 6 | — |
| polymerization initiator | | | | | | | | |
| Acridone based | nBCA | 2 | 2 | 2 | 2 | 4 | — | 6 |
| polymerization initiator | | | | | | | | |
| Basic dye | Green S-3G | 0.5 | 0.5 | 0.5 | 0.5 | 0.5 | 0.5 | 0.5 |
| Chromogenic dye | A-DMA | 1.5 | 1.5 | 1.5 | 1.5 | 1.5 | 1.5 | 1.5 |
| Solvent | PGME | 20 | 20 | 20 | 20 | 20 | 20 | 20 |

Note:
The abbreviations in Table 2 are as follow:
Resin 1: alkali-soluble acrylate resin obtained in Example 1
Resin 2: alkali-soluble acrylate resin obtained in Example 2
TMP(EO)₃TA: ethyleneoxide added trimethylpropanetriacetate (NIPPON KAYAKU Co. Ltd.)
BPA(EO)₁₀DA: ethyleneoxide added bisphenol A diacrylate(NIPPON KAYAKU Co. Ltd.),
I-819: bis(2,4,6-trimethylbenzoyl)-phenylphosphine oxide(Cibas specialty chemicals Inc.)
nBCA: n-butylcholoroacridon (KUROGANE KASEI Co. Ltd.)
DMA: leuco crystal violet(HODOGAYA CHEMICAL Co. Ltd.)
PGME: propyleneglycolmonomethylether.

The sensitivity, resolution, acid resistance in substrate etching process, and peeling property in alkali were tested for the photosensitive resin compositions of Examples 3 to 7, and Comparative Examples 1 to 2, and the test results are summarized in Table 3 below.

Sensitivity (mJ) is defined by multiplying intensity of illumination by time, and was determined by measuring with a diode laser of 405 nm in a 25 plate tablet mask.

Resolution was determined by reacting with 0.4 weight % Na₂CO₃ solution for 60 sec. after exposing to light of 10 mJ.

Acid resistance was determined by reacting with Aqua Regia for 60 sec. at 60° C.

Peeling property was determined by reacting with 5.0% MEA (monoethanolamine) solution for 40 sec. at 55° C.

TABLE 3

| | Sensitivity | Resolution | Acid resistance | Peeling property |
|---|---|---|---|---|
| Example 3 | 2.5 mJ | 10 μm | ◯ | ◯ |
| Example 4 | 2.0 mJ | 10 μm | ◯ | ◯ |
| Example 5 | 2.0 mJ | 10 μm | ◯ | ◯ |
| Example 6 | 1.5 mJ | 8 μm | ◯ | ◯ |
| Example 7 | 2.0 mJ | 10 μm | ◯ | ◯ |
| Comparative | 2.0 mJ | 20 μm | ◯ | Δ |
| Example 1 | | | | |
| Comparative | 4.5 mJ | 15 μm | ◯ | ◯ |
| Example 2 | | | | |

As shown in Table 3, the acid resistance and peeling property are indicated according to the following references: good (◯), bad (□), and very bad (X).

### EXAMPLE 8 TO 12 AND COMPARATIVE EXAMPLES 3 TO 4

### Preparation of Dry Film Resist

The photosensitive resin compositions obtained in Examples 3 to 7 and Comparative Examples 1 to 2 were coated with an applicator on polyethyleneterephthalate (PET) to a thickness of 25 μm as a first film, and dried to obtain a dry film of photosensitive resin composition with a final thickness of 20 μm. A polyethylene film as a second film was overlaid on the dry film with a 25 μm thickness, and then pressed with a rubber roller to remove air bubbles to produce the dry film resist.

The compositions of dry film resists obtained according to Examples 8 to 12 and Comparative Examples 3 to 4 are summarized in Table 4.

TABLE 4
(unit: parts by weight)

| | Photosensitive | | |
|---|---|---|---|
| Dry film resist | resin | First film | Second film |
| Example 8 | Example 3 | PET with | PE with |
| Example 9 | Example 4 | 25 μm thick | 25 μm thick |
| Example 10 | Example 5 | | |
| Example 11 | Example 6 | | |
| Example 12 | Example 7 | | |
| Comparative | Comparative | | |
| Example 3 | Example 1 | | |
| Comparative | Comparative | | |
| Example 4 | Example 2 | | |

The sensitivity, resolution, acid resistance in substrate etching process, and peeling property in alkali were tested for the dry film resists of Examples 8 to 12, and Comparative Examples 3 to 4, and the test results are summarized in Table 5 below.

Sensitivity (mJ) is defined by multiplying intensity of illumination by time, and was determined by measuring with a diode laser of 405 nm in a 25 plate tablet mask.

Resolution was determined by reacting with 0.4 weight % Na₂CO₃ solution for 60 sec. after exposing to light of 10 mJ.

Acid resistance was determined by reacting with Aqua Regia for 60 sec. at 60° C.

Peeling property was determined by reacting with 5.0% MEA (monoethanolamine) solution for 40 sec. at 55° C.

TABLE 5

| | | | | Peeling |
|---|---|---|---|---|
| | Sensitivity | Resolution | Acid resistance | property |
| Example 8 | 3.0 mJ | 10 μm | ◯ | ◯ |
| Example 9 | 2.5 mJ | 10 μm | ◯ | ◯ |
| Example 10 | 2.5 mJ | 10 μm | ◯ | ◯ |
| Example 11 | 2.0 mJ | 8 μm | ◯ | ◯ |
| Example 12 | 2.5 mJ | 10 μm | ◯ | ◯ |
| Comparative | 2.5 mJ | 20 μm | ◯ | Δ |
| Example 3 | | | | |
| Comparative | 5.0 mJ | 15 μm | ◯ | ◯ |
| Example 4 | | | | |

In Table 5, the acid resistance and peeling property are indicated according to the following references: good (◯), bad (Δ), and very bad (X).

As shown in Table 5, the dry film resist of Examples 8 to 12 could form the pattern at low sensitivity, and had excellent resolution, acid resistance, and peeling property compared to those of Comparative Examples 3 and 4.

According to the photosensitive resin composition and the dry film resist, it is easy to finely pattern using a laser direct image with high density and the dry film has excellent sensitivity, resolution, and adhesiveness to the substrate.

What is claimed is:

1. A photosensitive resin composition comprising a) an alkali-soluble acrylate resin, b) a cross-linking monomer having at least two ethylenic double bonds, c) a phosphine oxide based photopolymerization initiator and an acridon based photopolymerization initiator.

2. The photosensitive resin composition according to claim 1, wherein the photosensitive resin composition comprises 40 to 100 parts by weight of the cross-linking monomer having at least two ethylenic double bonds, and 1.5 to 7 parts by weight of the phosphine oxide based photopolymerization initiator and the acridon based photopolymerization initiator based on 100 parts by weight of the alkali-soluble acrylate resin.

3. The photosensitive resin composition according to claim 1, wherein the alkali-soluble acrylate resin has a weight-average molecular weight of 20,000 to 100,000.

4. The photosensitive resin composition according to claim 3, wherein the alkali-soluble acrylate resin has a weight-average molecular weight of 30,000 to 70,000.

5. The photosensitive resin composition according to claim 1, wherein the alkali-soluble acrylate resin has a glass transition temperature of 100° C. or more.

6. The photosensitive resin composition according to claim 1, wherein the alkali-soluble acrylate resin is prepared by polymerizing at least one selected from the group consisting of i) an unsaturated carboxylic acid monomer monomer, ii) an aromatic monomer, iii) a phosphate ester-containing monomer, and iv) an aliphatic acrylic monomer.

7. The photosensitive resin composition according to claim 6, wherein the alkali-soluble acrylate resin is prepared by polymerizing a mixture of 20 to 50 weight % of the unsaturated carboxylic acid monomer, 15 to 45 weight % of the aromatic monomer, 1 to 15 weight % of the phosphate ester-containing monomer, and 10 to 50 weight % of the aliphatic acrylic monomer.

8. The photosensitive resin composition according to claim 6, wherein the unsaturated carboxylic acid monomer is at least one selected from the group consisting of acrylic acid, methacrylic acid, itaconic acid, maleic acid, furmaric acid, vinyl acetate and acid anhydrides thereof.

9. The photosensitive resin composition according to claim 6, wherein the aromatic monomer is at least one selected from the group consisting of styrene, benzylmethacrylate, benzylacrylate, phenylacrlyate, phenylmethaacrlyate, 2-nitrophenylacrlyate, 4-nitrophenylacrlyate, 2-nitrophenylmethaacrlyate, 4-nitrophenylmethaacrlyate, 2-nitrobenzylmethacrylate, 4-nitrobenzylmethacrylate, 2-chlorophenylacrlyate, 4-chlorophenylacrlyate, 2-chlorophenylmethaacrlyate, and 4-chlorophenylmethaacrlyate.

10. The photosensitive resin composition according to claim 6, wherein the phosphate ester-containing monomer is at least one selected from the group consisting of pentaethyleneglycol phosphate monomethacrylate, pentapropyleneglycol phosphate monomethacrylate, and hexaethyleneglycol phosphate monomethacrylate.

11. The photosensitive resin composition according to claim 6, wherein the aliphatic acrylic monomer is at least one selected from the group consisting of 2-hydroxyethylacrylate, 2-hydroxyoctylacrylate, methylacrylate, ethylacrylate, 2-hydroxyethyl methacrylate, 2-hydroxyoctylmethacrylate, methylmethacrylate, ethyl methacrylate, and n-butylacrylate.

12. The photosensitive resin composition according to claim 1, wherein the cross-linking monomer is at least one selected from the group consisting of 1,4-butanediacrylate, 1,3-butyleneglycoldiacrylate, ethyleneglycoldiacrylate, pentaerythritoltetraacrylate, triethyl leneglycoldiacrylate, polyethyleneglycoldiacrylate, dipentaerythritoldiacrylate, solbitoltriacrylate, bisphenol A diacrylate derivative, trimethylpropanetriacrylate, ethyleneoxide added triethylpropanetriacrylate, dipentaerythritolpolyacrylate, 1,4-butanedioldimethacrylate, 1,3-butylleneglycoldimethacrylate, ethyl leneglycoldimethacrylate, pentaerythritoltetramethacrylate, triethyleneglycoldimethacrylate, polyethyleneglycoldimethacrylate, dipentaerythritoldimethacrylate, solbitoltrimethacrylate, bisphenol A dimethacrylate derivative, trimethylpropanetrimethacrylate, ethyleneoxide added trimethylpropanetri methacrylate, and dipentaerythritolpolymethacrylate.

13. The photosensitive resin composition according to claim 1, wherein the phosphine oxide based photopolymerization initiator is at least one selected from the group consisting of the compounds represented by the following formula 1: 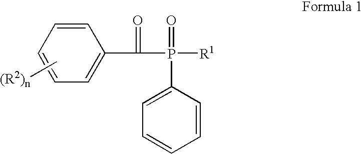
wherein, R¹ is a phenyl, alkyl, or trialkylbenzoly group, R² is independently a C1 to C6 alkyl group, and n is an integer of 0 to 3.

14. The photosensitive resin composition according to claim 1, wherein the acridon based photopolymerization initiator is at least one selected from the group consisting of the compounds represented by the following formula 2: 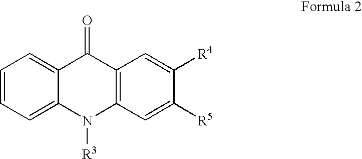
wherein, R³ is a C1 to C6 alkyl, R⁴ is a C1 to C2 alkyl or a halogen, and R⁵ is a C1 to C2 alkyl or a halogen.

15. The photosensitive resin composition according to claim 1, wherein the photosensitive resin composition further comprises at least one dye selected from the group consisting of leuco crystal violet, tribromomethylphenylsulfone, diamond green GH, Rhodamine B, auramine base, paramagenta, methyl orange, methylene blue, crystal violet, ethyl violet, pthalocyanine green, mansic blue 20, and Light green B.

16. The photosensitive resin composition according to claim 1, wherein the photosensitive resin composition further comprises an additive for improving the coating property.

17. The photosensitive resin composition according to claim 1, wherein the photosensitive resin composition further comprises at least one solvent selected from the group consisting of ethyleneglycolmonomethyletheracetate, propyleneglycolmonomethylether, propyleneglycolmethyletheracetate, propyleneglycolmonoethyletheracetate, diethyl leneglycoldimethylether, diethyleneglycolmethylethylether, cyclohexanone, 3-methoxypropionic acid ethyl, 3-ethoxypropionic acid methyl, 3-ethoxypropionic acid ethyl, methylethylketone, isopropylalcohol, ethanol, and methanol.

18. A method of preparing a photosensitive resin composition comprising the steps of:
polymerizing at least one monomer selected from the group consisting of an unsaturated carboxylic acid monomer, an aromatic monomer, a phosphate ester-containing monomer, and an aliphatic acrylic monomer to produce an alkali-soluble acrylate resin; and
mixing the alkali-soluble acrylate resin, a cross-linking monomer having at least two ethylenic double bonds, a phosphine oxide based photopolymerization initiator, and an acridon based photopolymerization initiator.

19. The method of preparing a photosensitive resin composition according to claim 18, wherein the unsaturated carboxylic acid monomer is at least one selected from the group consisting of acrylic acid, methacrylic acid, itaconic acid, maleic acid, furmaric acid, vinyl acetate, and an acid anhydride thereof.

20. The method of preparing a photosensitive resin composition according to claim 18, wherein the aromatic monomer is at least one selected from the group consisting of styrene, benzylmethacrylate, benzylacrylate, phenylacrlyate, phenylmethaacrlyate, 2-nitrophenylacrlyate, 4-nitrophenylacrlyate, 2-nitrophenylmethaacrlyate, 4-nitrophenylmethaacrlyate, 2-nitrobenzylmethacrylate, 4-nitrobenzylmethacrylate, 2-chlorophenylacrlyate, 4-chlorophenylacrlyate, 2-chlorophenylmethaacrlyate, and 4-chlorophenylmethaacrlyate.

21. The method of preparing a photosensitive resin composition according to claim 18, wherein the phosphate ester-containing monomer is at least one selected from the group consisting of pentaethyleneglycol phosphate monomethacrylate, pentapropyleneglycol phosphate monomethacrylate, and hexaethyleneglycol phosphate monomethacrylate.

22. The method of preparing a photosensitive resin composition according to claim 18, wherein the aliphatic acrylic monomer is at least one selected from the group consisting of 2-hydroxyethylacrylate, 2-hydroxyoctylacrylate, methylacrylate, ethylacrylate, 2-hydroxyethyl methacrylate, 2-hydroxyoctylmethacrylate, methylmethacrylate, ethyl methacrylate, and n-butylacrylate.

23. The method of preparing a photosensitive resin composition according to claim 18, wherein the cross-linking monomer is at least one selected from the group consisting of 1,4-butanediacrylate, 1,3-butyleneglycoldiacrylate, ethyl eneglycoldiacrylate, pentaerythritoltetraacrylate, triethyl leneglycoldiacrylate, polyethyleneglycoldiacrylate, dipentaerythritoldi acrylate, solbitoltriacrylate, bisphenol A diacrylate derivative, trimethylpropanetriacrylate, ethyleneoxide added triethylpropanetriacrylate, dipentaerythritolpolyacrylate, 1,4-butanedioldimethacrylate, 1,3-butylleneglycoldimethacrylate, ethyl leneglycoldimethacrylate, pentaerythritoltetramethacrylate, triethyleneglycoldimethacrylate, poly ethyleneglycoldimethacrylate, dipentaerythritoldimethacrylate, solbitoltrimethacrylate, bisphenol A dimethacrylate derivative, trimethylpropanetrimethacrylate, ethyleneoxide added trimethylpropanetri methacrylate, and dipentaerythritolpolymethacrylate.

24. The method of preparing a photosensitive resin composition according to claim 18, wherein the phosphine oxide based photopolymerization initiator is at least one selected from the group consisting of the compounds represented by the following formula 1: 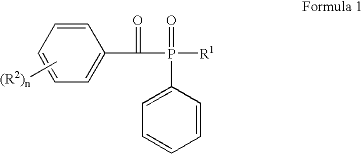
wherein, R¹ is a phenyl, alkyl, or trialkylbenzoly group, R² is independently a C1 to C6 alkyl group, and n is an integer of 0 to 3.

25. The method of preparing a photosensitive resin composition according to claim 18, wherein the acridon based photopolymerization initiator is at least one selected from the group consisting of the compounds represented by the following formula 2: 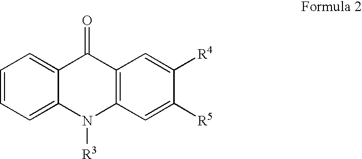
wherein, R³ is a C1 to C6 alkyl, R⁴ is a C1 to C2 alkyl or a halogen, and R⁵ is a C1 to C2 alkyl or a halogen.

26. A photosensitive dry film resist comprising the photosensitive resin composition according to claim 1.
